(19) United States
(12) Patent Application Publication
(10) Pub. No.: US 2010/0293720 A1
(43) Pub. Date: Nov. 25, 2010

(54) Crimping tool with an electronic counting device

(75) Inventor: Lei Zhang, Tianjin (CN)

Correspondence Address: ZHEN ZHENG LU, 1730 HUNTINGTON DRIVE #304, DUARTE, CA, 91010, US

(73) Assignee: LINK-TECH (TIANJIN) METAL PRODUCTS CO., LTD.

(21) Appl. No.: 12/468,183

(22) Filed: May 19, 2009

(51) Int. Cl. B25B 7/22

(52) U.S. Cl. 7/125

(57) ABSTRACT

A crimping tool with an electronic counting device includes a head, a handle and a counting device, wherein the head comprises a left jaw and a right jaw, the handle comprises a left handle and right handle, the head is connected with the handle via a pin and the left and right handle form a U-shaped groove, wherein a counting device is disposed inside the U-shaped groove at the upper portion of one handle, which comprises a housing, a cover, a circuit board, a LCD display and a dry reed tube, wherein the counting device is connected with the handle via a screw.

### BACKGROUND OF THE PRESENT INVENTION

1. Field of Invention

The present invention relates to a hardware tool, and more particularly to a crimping tool with an electronic counting device.

2. Description of Related Arts

The crimping tool is widely used for connecting pipes and cables. Plastic pipes (water pipe) are connected with pipe fittings (two-way and three-way) mostly via a corresponding copper ring. When a pipe is connected with a pipe fitting, the pipe is inserted into the pipe fitting, and a corresponding copper ring is put on the pipe fitting and pressed by snap ring pliers so as to tightly connect the pipe and the pipe fitting. In the prior art, the crimping tool mainly includes a head and a handle, wherein the head comprises a left jaw and a right jaw that are connected via two side covers, and semicircle die is provided in the opening between the jaws for pressing copper ring. During usage, first open the jaws through left and right handle and put the crimping ring inside the die, and then press the crimping ring via the handle, so as to tightly connect the pipe and the pipe fitting. The above-mentioned crimping tool only has mechanical transmission and does not have electronic display to show the operating status of the crimping tool, so that the user may easily miss some connections in a project so as to affect the project quality and lower the working efficiency. The present invention eliminates the drawback of the prior art and provides a crimping tool with a real-time electronic counting function.

### SUMMARY OF THE PRESENT INVENTION

An object of the present invention is to provide a crimping tool with an electronic counting device.

Accordingly, in order to accomplish the above object, the present invention provides a crimping tool with an electronic counting device, which includes a head, a handle and a counting device, wherein the head comprises a left jaw and a right jaw, the handle comprises a left handle and right handle, the head is connected with the handle via a pin, and the left and right handle form a U-shaped groove, wherein a counting device is disposed in the U-shaped groove at the upper portion of one handle, which comprises a housing, a cover, a circuit board, a LCD display and a dry reed tube, wherein the counting device is connected with the handle via a screw.

The handle has a groove at an inner side thereof, and a magnet is disposed in the groove. When the handle moves to a closing position, the dry reed tube can display counting result due to magnetic induction.

The counting device is disposed in the U-shaped groove at the upper portion of the handle. The counting device can show the working status of the crimping tool and monitor the operating times of the crimping tool.

The counting device comprises a housing, a cover, a LCD display, and a dry reed tube. The cover has a positioning column and a convex column. The convex column has a hole in center corresponding to the hole of the circuit board, so that the cover is connected with the circuit board via a screw. The housing has a positioning slot at the outer edge of the bottom of the housing. Insert the circuit board into the positioning slot, so that the circuit board, the housing and the cover are connected together. The dry reed tube is disposed inside the housing and connected with the circuit board via a wire. The LCD display is embedded into the cover. The counting device is connected to the left handle via a screw.

The crimping tool includes snap ring pliers, side cutting pliers, and double headed pliers and so on.

The counting device can be applied to different kinds of crimping tools.

The operating theory is that when a pipe is connected with a pipe fitting, the pipe is inserted into the pipe fitting, and a corresponding copper ring is put on the pipe fitting and pressed by a crimping tool so as to tightly connect the pipe and the pipe fitting. In use, first open the head via left and right handle and put the crimping ring inside the die, and then press the crimping ring via handle, so as to tightly connect the pipe and the pipe fitting. When the handle moves to a closing position, the dry reed tube can display counting result due to magnetic induction, illustrating that the crimping operation is completed for one time.

The advantage of the present invention is that the present invention has a subtle structure and has a LCD with a counting function during the crimping to display the crimping times of the crimping tool. The user can check the operating status, so as to reduce the misconnection and improve the working efficiency. The counting device is simple in structure and has accurate counting result. The counting result can be applied to all kinds of crimping tool and is convenient to use.

### BRIEF DESCRIPTION OF THE DRAWINGS

FIG. 1 is a perspective view of a crimping tool according to a first example of the present invention.

FIG. 2 is a perspective view of a crimping tool according to a second example of the present invention.

FIG. 3 is a perspective view of a counting device according to the present invention.

### DETAILED DESCRIPTION OF THE PREFERRED EMBODIMENT

Based on the above-mentioned structure, the features of a crimping tool with an electronic counting device will become apparent from the following detailed description.

### Example I

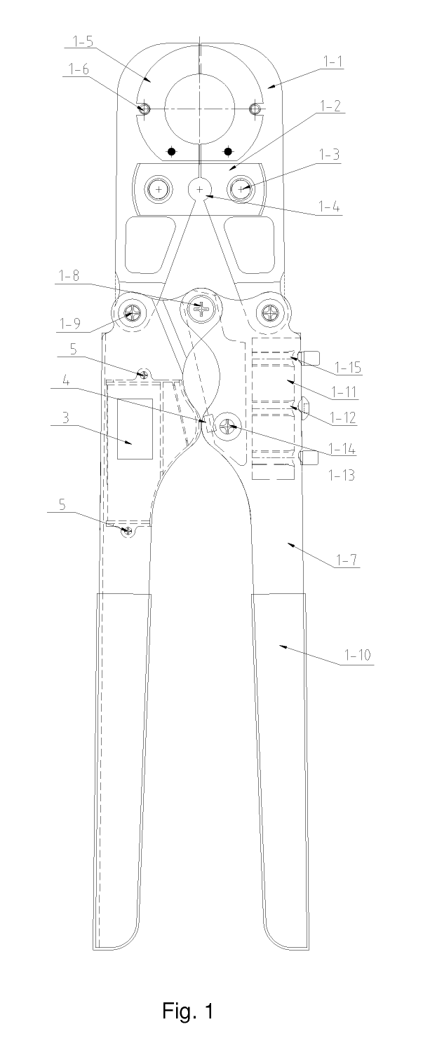

Referring to FIG. 1 of the drawings, a crimping tool with an electronic counting device of the present invention is illustrated, in which the crimping tool with an electronic counting device comprises a head 1-1 and a handle 1-7. The head comprises a left jaw and a right jaw. The centers of the left and right jaw are connected with a head pin 1-3 respectively via two side covers 1-2, and the left and right jaw can rotate around the head pin 1-3 respectively. A center shaft 1-4 is provided in the center of the head between the two side covers 1-2. The opening of the head is a semicircle. A changeable semicircle die 1-5 is provided to cover the opening of head from outside, and is fastened via a screw 1-6. The handle 1-7 comprises a left handle and a right handle. The inner side of the upper portion of the left handle and the right handle are connected via a handle pin 1-8 and can rotate around the handle pin 1-8. The outer side of the upper portion of the left handle and the right handle are connected with the lower portion of the left jaw and the right jaw respectively via a tail screw, and can rotate around the tail screw respectively. The handle 1-7 forms a U-shaped groove. The lower portion of the left handle and right handle of the handle 1-7 are covered by two handle covers 1-10 respectively. In order to adjust the closure of the die 1-5 and the force of the handle 1-7, an adjusting unit is provided in the U-shaped groove at the upper portion of the right handle, which comprises a adjusting panel 1-11, a supporting panel 1-13 and a adjusting screw 1-15. The adjusting panel 1-11 is fastened to the right handle outside the U-shaped groove via a screw 1-12, the supporting panel 1-13 is fastened to the U-shaped groove via a screw 1-14 and can rotate around the handle pin 1-8, and the adjusting screw 1-15 passes through the adjusting panel 1-11 from the outer side of the right handle and is against the supporting panel 1-13. A counting device 3 is disposed in the U-shaped groove at the upper portion of the left handle.

The handle 1-7 has a groove at an inner side thereof, and a magnet 4 is disposed in the groove. When the handle 1-7 moves to a closing position, a dry reed tube 3-5 can display counting result due to the magnetic induction.

A counting device 3 is disposed in the U-shaped groove at the upper portion of the left handle. The counting device 3 can show the working status of the crimping tool and monitor the operating times of the crimping tool.

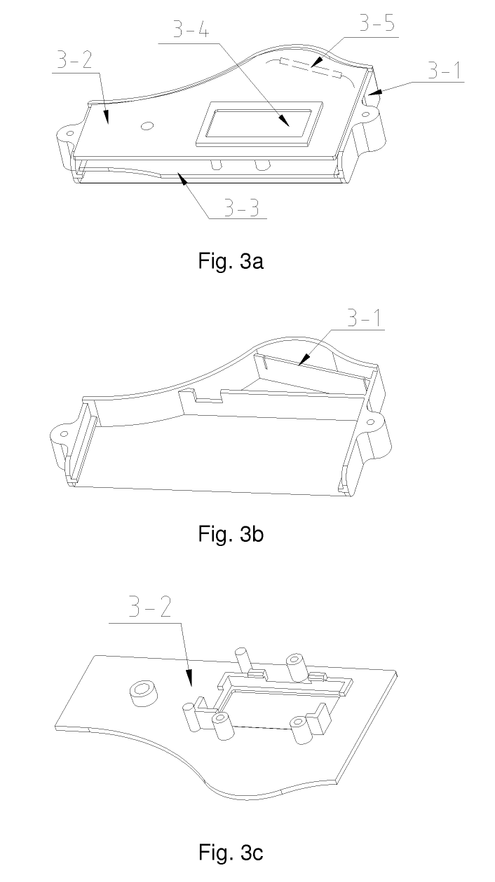

The counting device 3, as shown in FIG. 3, comprises a housing 3-1, a cover 3-2, a LCD display 3-4, and a dry reed tube 3-5. The cover 3-2 has a positioning column and a convex column. The convex column has a hole in center corresponding to the hole of the circuit board 3-3, so that the cover is connected with the circuit board via a screw 5. The housing 3-1 has a positioning slot at the outer edge of the bottom of the housing. Insert the circuit board 3-3 into the positioning slot, so that the circuit board 3-3, the housing 3-1 and the cover 3-2 are connected together. The dry reed tube 3-5 is disposed inside the housing 3-1 and connected with the circuit board 3-3 via a wire. The LCD display 3-4 is embedded into the cover 3-2. The counting device 3 is connected to the left handle via a screw 5.

The above-mentioned crimping tool is convertible snap ring pliers shown in FIG. 1.

### Example II

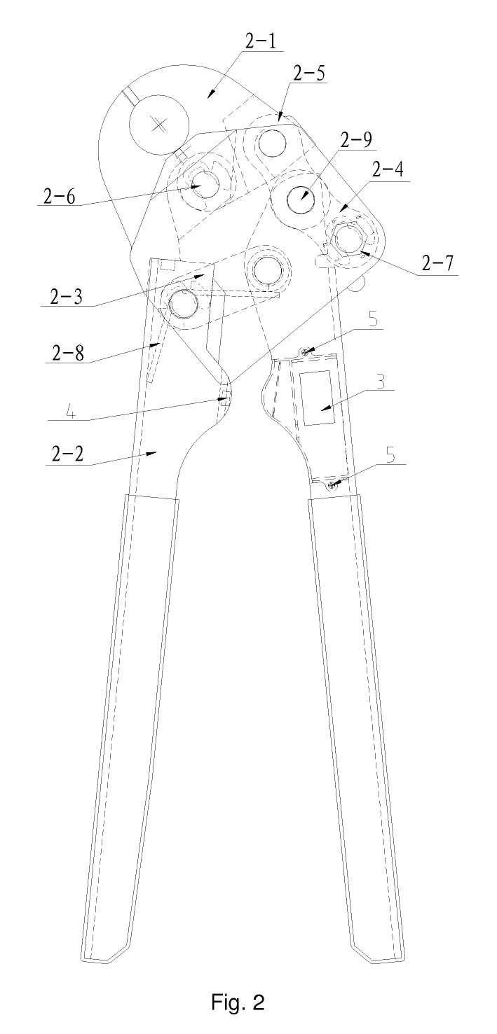

Referring to FIG. 2 of the drawings, a crimping tool with an electronic counting device of the present invention is illustrated, in which the crimping tool with an electronic counting device comprises a head 2-1 and a handle 2-2. The head 2-1 comprises a left jaw and a right jaw. The centers of the left and right jaw are connected with a head pin 2-6 respectively, and can rotate around the head pin 2-6 respectively. The opening of the head 2-1 is a semicircle. The handle 2-2 comprises a left handle and a right handle. A third connecting plate 2-5 has one end connecting to the right jaw via a pin 2-9, and the other end connecting to the right handle and a second connecting plate 2-4 at one end. The second connecting plate 2-4 has the other end connecting to the left jaw via an eccentric axis 2-7. A first connecting plate 2-3 has one end connecting to the left jaw and left handle via a head pin 2-6, and the other end connecting to the right handle via a pin 2-9. A counting device 3 is disposed in the U-shaped groove at the front of the right handle.

The handle 2-2 has a groove at an inner side thereof, and a magnet 4 is disposed in the groove. When the handle 2-2 is moves to a closing position, a dry reed tube 3-5 can display counting result due to the magnetic induction.

A counting device 3 is disposed in the U-shaped groove at the upper portion of the handle 2-2. The counting device 3 can show the working status of the crimping tool and monitor the operating times of the crimping tool.

The counting device 3, as shown in FIG. 3, comprises a housing 3-1, a cover 3-2, a LCD display 3-4, and a dry reed tube 3-5. The cover 3-2 has a positioning column and a convex column. The convex column has a hole in center corresponding to the hole of the circuit board 3-3, so that the cover is connected with the circuit board via a screw 5. The housing 3-1 has a positioning slot at the outer edge of the bottom of the housing. Insert the circuit board 3-3 into the positioning slot, so that the circuit board 3-3, the housing 3-1 and the cover 3-2 are connected together. The dry reed tube 3-5 is disposed inside the housing 3-1 and connected with the circuit board 3-3 via a wire. The LCD display 3-4 is embedded into the cover 3-2. The counting device 3 is connected to the left handle via a screw 5.

The above-mentioned crimping tool is side cutting pliers shown in FIG. 2.

What is claimed is:

1. A crimping tool with an electronic counting device, comprising
a head comprising a left jaw and a right jaw;
a handle comprising a left handle and right handle, wherein the head is connected with the handle via a pin, and the left and right handle form a U-shaped groove; and
a counting device disposed inside the U-shaped groove at an upper portion of one handle, wherein the counting device is connected with the handle via a screw.

2. The crimping tool with an electronic counting device, as recited in claim 1, wherein the handle has a groove at an inner side thereof, and a magnet is disposed in the groove, so that when the handle moves to a closing position, the dry reed tube can display counting result due to magnetic induction.

3. The crimping tool with an electronic counting device, as recited in claim 1, wherein the counting device is disposed in the U-shaped groove at the upper portion of the handle, wherein the counting device can show the working status of the crimping tool and monitor operating times of the crimping tool.

4. The crimping tool with an electronic counting device, as recited in claim 1, wherein the counting device comprises a housing, a cover, a LCD display, and a dry reed tube, wherein the cover has a positioning column and a convex column, the convex column has a hole in center corresponding to a hole of the circuit board, so that the cover is connected with the circuit board via a screw, and the housing has a positioning slot at an outer edge of a bottom of the housing, wherein insert the circuit board into the positioning slot, so that the circuit board, the housing and the cover are connected together, wherein the dry reed tube is disposed inside the housing and connected with the circuit board via a wire, the LCD display is embedded into the cover, and the counting device is connected to the left handle via a screw.

5. The crimping tool with an electronic counting device, as recited in claim 2, wherein the counting device comprises a housing, a cover, a LCD display, and a dry reed tube, wherein the cover has a positioning column and a convex column, the convex column has a hole in center corresponding to a hole of the circuit board, so that the cover is connected with the circuit board via a screw, and the housing has a positioning slot at an outer edge of a bottom of the housing, wherein insert the circuit board into the positioning slot, so that the circuit board, the housing and the cover are connected together, wherein the dry reed tube is disposed inside the housing and connected with the circuit board via a wire, the LCD display is embedded into the cover, and the counting device is connected to the left handle via a screw.

6. The crimping tool with an electronic counting device, as recited in claim 3, wherein the counting device comprises a housing, a cover, a LCD display, and a dry reed tube, wherein the cover has a positioning column and a convex column, the convex column has a hole in center corresponding to a hole of the circuit board, so that the cover is connected with the circuit board via a screw, and the housing has a positioning slot at an outer edge of a bottom of the housing, wherein insert the circuit board into the positioning slot, so that the circuit board, the housing and the cover are connected together, wherein the dry reed tube is disposed inside the housing and connected with the circuit board via a wire, the LCD display is embedded into the cover, and the counting device is connected to the left handle via a screw.

7. The crimping tool with an electronic counting device, as recited in claim 1, wherein the crimping tool is embodied as snap ring pliers, side cutting pliers, or double headed pliers.

8. The crimping tool with an electronic counting device, as recited in claim 1, wherein the counting device can be applied to various kinds of crimping tool.

9. The crimping tool with an electronic counting device, as recited in claim 3, wherein the counting device can be applied to various kinds of crimping tool.

10. The crimping tool with an electronic counting device, as recited in claim 4, wherein the counting device can be applied to various kinds of crimping tools.
